(19) United States
(12) Patent Application Publication
(10) Pub. No.: US 2012/0084181 A1
(43) Pub. Date: Apr. 5, 2012

(54) TENANT STORE SALES PROMOTION MANAGEMENT SYSTEM

(75) Inventors: Hisashi Miura, Tokyo (JP); Susumu Isozaki, Kanagawa (JP)

(73) Assignees: Susumu Isozaki, Yokohama-shi, Kanagawa (JP); Miura Printing Corporation, Tokyo (JP)

(21) Appl. No.: 13/376,794

(22) PCT Filed: Jun. 18, 2010
(86) PCT No.: PCT/JP2010/060341

§ 371 Date: Dec. 7, 2011

(30) Foreign Application Priority Data
Jun. 25, 2009 (JP) 2009-150435

(51) Int. Cl. G06Q 30/00

(52) U.S. Cl. 705/27.1

(57) ABSTRACT

A tenant store sales promotion management system. Various kinds of products displayed on product display shelves in the sales space and products for restocking at an inventory storage location of the sales space are presented for sale at the virtual store on the Internet through a system server of the tenant store sales promotion management system. Presenting the product for sale at the virtual store is automatically executed when a sales clerk of the sales space registers products for sale at the sales space in a POS cash register and the product information is read by a terminal communication device and transmitted to the system server. Management of the sale is automatically performed by the system server, and the result is reported to the sales space through the terminal communication device.

### TECHNICAL FIELD

The present invention relates to a tenant store sales promotion management system.

### BACKGROUND ART

Conventionally, in large retail stores, e.g., department stores and the like, sectioned sales spaces on each floor have been rented, sales-space lessee's products have been exhibited in each of the sales spaces, and a store clerk (hereinafter referred to as salespersons or sales clerks) of the lessee has been dispatched to each of the sales spaces.

What is called a tenant store system has been widely adopted, wherein the salesperson sells a desired product to a customer (hereinafter referred to as a purchaser) who comes to the large retail store to purchase the product in a face-to-face selling manner.

In this case, the sales of the tenant store are processed using a cash register (hereinafter referred to as a register) securely installed in the sales space. In the past, inmost cases, the salesperson input the product code of a sold product and the amount the sale into the register in a manual fashion.

Recently, however, the product name of a sold product and the amount of the sale have been recorded in a register by simply causing a code reader connected to the register to read a product code attached to the product or printed on the packing bag.

The register is lent from the large retail store to the tenant store, and the sales recorded in the register are recorded in a computer of the large retail store as sales of each sales space.

Recently, as described above, the sales of a sales space have been recorded in the computer of a large retail store in real time. However, tenant stores have been taking an inventory of products entirely by themselves.

In the meantime, recently, large retail stores have been seeking multilateral increases in sales. Among other things, increasing sales using a virtual store on the internet has been considered to be an effective method.

As a general rule, anyone can establish a virtual store on the internet; however, registering with a famous specialized portal site is believed to be more advantageous for increasing sales since many visits can be expected.

In regard to increasing sales by using a virtual store on the internet relating to books, the following are proposed to be provided: a sales data file which saves the number of sold books, sale dates of books, interest levels, and the like; book-arrangement method knowledge which accumulates arrangement rules defined in accordance with arrangement rules of books in stores in the real world; a book-arrangement method determination engine which determines an arrangement method in accordance with sales data; a book-arrangement image generation engine which, in accordance with the determined book-arrangement method, processes images of covers, spines, and the like of books, images of bookshelves, and the like obtained from an image data file, so as to generate images capable of being displayed by a client apparatus and showing books arranged on the bookshelves (see, for example, patent document 1).

Meanwhile, in regard to a typical Internet commodity transaction system, an internet commodity transaction system provided with the following is proposed: a user terminal, a site administrator terminal, and a provider-side server, each connected to the internet; a product-sales top screen in which a virtual store and the like constructed within the server are displayed; a product database of products having attributes which are exhibited in a virtual store and the like, the product database being on the server side; a specific-product keyword search field displayed within a portion of the product-sales top screen, the specific-product keyword search field being for searching for novel products and the like; a product attribute management subroutine of a control program, the product attribute management subroutine being for appropriately adding an attribute (e.g., a virtual store) to a product in the product database, or for deleting an attribute; and a product order management subroutine of the control program, the product order management subroutine being for processing an order for a product from a user terminal (see, for example, patent document 2).

### PRIOR ART DOCUMENTS

### Patent Documents

Patent document 1: Japanese Laid-open Patent Publication No. 2002-216014

Patent document 2: Japanese Laid-open Patent Publication No. 2005-100059

### DESCRIPTION OF THE RELATED ART

In the prior arts in both patent documents 1 and 2, detailed descriptions are given of data organization and management organization of a server on the site side for establishing a virtual store; however, no clear descriptions are given of a procedure for registering a virtual store and product information in the site. Alternatively, only a method is disclosed in which complicated manual input operations are performed using a personal computer.

In fact, however, when an attempt is made to present products currently presented at the storefront (i.e., sales space) of a tenant store in a large retail store (e.g., a department store) for sale also at a virtual store on the internet, the number of the products to be presented for sale is separated from the inventory data of the sales space, which is stored in an inventory database which counts sales registered in the register machine, and the separated products are defined tentatively sold products and the number of these separated products are counted as fictitious sales.

When the products remain unsold at the virtual store on the internet despite the intentions of the planner, they are again incorporated into the inventory at the sales space (i.e. the storefront inventory) through a product returning process or they are incorporated into the inventory at the sales space as newly purchased inventory through preparation of an inventory-purchase slip. There were only these two modes of processing, only one of which can be selected at a time.

To perform such a process, a dedicated operator, which is different from a salesperson at the tenant store, was allocated in a dedicated room. When an attempt was made to present a product for sale, the operator input product information to be registered in the virtual store on the internet. When a product presented for sale at the virtual store was removed, a slip process as described above was performed.

Accordingly, the cost of equipment and the labor cost for manual input operations became huge relative to the sales profit obtained from the selling of products registered in a virtual store on the internet, with the result that there was a problem in which the actual profit from multilateral increasing of sales was not as expected.

### MEANS FOR SOLVING THE PROBLEMS

To solve the problem above, the tenant store sales promotion management system in accordance with the present invention includes: a product information recording device provided at a sales space for selling products, which records, via an input operation by a sales clerk, product information composed of at least a product name code, initial inventory quantity data, sales price data, sales volume data, and the like relating to the products; a terminal communication device which is exclusively connected to the product information recording device in a wired or wireless fashion and which is capable of communicating, through a radio communication network, the product information and image data of the product included in the products registered in the product information recording device and designated via an external input; and a server which belongs to a company owning the terminal communication device and which communicates with the terminal communication device through the radio communication network, wherein the server performs: a process for obtaining, via the communication with the terminal communication device, virtual store data composed of at least the image data, the product code, the inventory quantity data, and sales price data of the designated product and information for identifying the sales space; a process for storing the virtual store information in a predetermined database; a process for registering the virtual store information in the database in a virtual store reception site connected to the radio communication network; a process for obtaining sales information of the product sold at the virtual store; a process for transmitting the obtained sales information to the terminal communication device; and a process for charging a purchaser who purchased the product at the virtual store for the product on the basis of the sales information.

In the tenant store sales promotion management system, the sales spaces include, for example, a tenant store in a large retail store, a wholesale company, a private shop, a product manufacturing factory, or a nonstore-type private vendor, and the product information recording devices include, for example, a cash register or a personal computer.

In the tenant store sales promotion management system, a product designated via an input operation by the sales clerk is given, for example, a product code, sales price data, and inventory data which are different from those of the products presented for sale at the sales space, is designated as a clearance sale object, and is registered in the product information recording device.

In addition, in the tenant store sales promotion management system, the terminal communication device is provided with a plurality of connection ports connectable to a product code issuance machine, a product code reader, a product image shooting machine, and a language translating machine.

### EFFECT OF THE INVENTION

The present invention has the advantage that the sales volume (i.e., the number of sold products) of products can increase with little effort since the sales of the same product under the same inventory via over-the-counter sales at a sales space and a virtual store on a radio communication network can be developed concurrently.

### BRIEF DESCRIPTION OF THE DRAWINGS

FIG. 1 is a diagram showing the entire configuration of a tenant store sales promotion management system in accordance with embodiment 1 of the present invention.

FIG. 2 is a diagram showing a representative configuration example on the floor surface of one floor of a large retail store as an example of the membership formation in the tenant store sales promotion management system in accordance with embodiment 1.

FIG. 3 is a diagram schematically showing the configuration in the sales space on the floor surface shown in FIG. 2.

FIG. 4 is a diagram showing details of the configuration of a terminal communication device provided at a sales space together with a POS register.

FIG. 5 is a diagram showing some examples of an input device used by a salesperson at a cash desk in a sales space to transmit product information of a product to be presented for sale at a virtual store on the internet to a system server of the tenant store sales promotion management system.

FIG. 6 is a diagram showing a code-issuance machine for issuing a product code ticket to be attached to a product at a sales space and showing a reader for reading the product code ticket.

FIG. 7 is a diagram showing examples of a product to which a price tag is attached, the price tag having an issued product code attached to it.

FIG. 8 is a diagram showing an example of a virtual-store product code issued by a code-issuance machine and a use for it.

FIG. 9 is a diagram showing a situation in which a price tag 38 is attached to the various products shown in FIG. 7 as examples of sales products, the price tag 38 having attached to it a sales-space product code 37 and a virtual-store product code 48 which are next to each other.

FIG. 10 is a diagram illustrating processing functions of a system server which receives an offer to present a product currently exhibited at a sales space for sale at a virtual store.

FIG. 11 is a block diagram showing a system configuration of the system server provided with the function in FIG. 10.

FIG. 12 is a flowchart illustrating a process operation by a terminal communication device and a process operation by the system server, the process operations being based on decision making of a salesperson who sells products at a sales space and a virtual store.

FIG. 13 is a diagram showing a relationship between processes performed on the purchaser side of a product at the virtual store and processes performed on the system server side.

FIG. 14 is a diagram showing examples of various input terminal devices which can be used by a purchaser.

FIG. 15 is a diagram showing examples of exhibited products at the virtual store which are displayed on a display screen of an input terminal device of a purchaser.

FIG. 16 is a diagram showing a small-size terminal communication device and peripheral instruments which are used by a nonstore-type private vendor to present a product for sale at a virtual store, wherein the nonstore-type private vendor is a member of the tenant store sales promotion management system.

### DESCRIPTION OF THE PREFERRED EMBODIMENTS

In the following, embodiments of the present invention will be described in detail.

### Embodiment 1

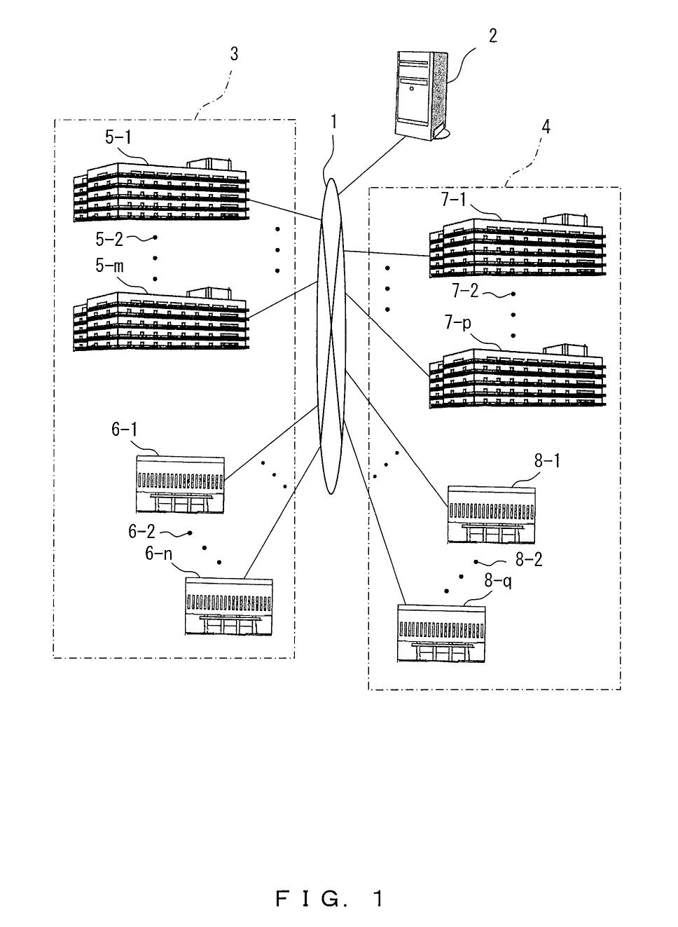

FIG. 1 is a diagram showing the entire configuration of a tenant store sales promotion management system in accordance with embodiment 1 of the present invention.

As shown in FIG. 1, in the tenant store sales promotion management system in accordance with the present embodiment, a radio communication network 1 (e.g., the internet) has connected to it a system server 2 of a system administration company which owns a plurality of product information recording devices (these will be described hereafter) and which lends these product information recording devices to members, and a credit server (not shown) which constructs a CAFIS (Credit And Finance System) of a payment clearing company (a credit card company) that has a tie-up with the system administration company and thus makes the payment for a sold product on behalf of a purchaser.

In addition, the radio communication network 1 has a domestic membership-system 3 and a foreign membership-system 4 connected to it. The domestic membership-system 3 is composed of a plurality of large retail stores 5 (5-1, 5-2, . . . , 5-m) (m=1, 2, 3, . . . ) and general companies 6 (6-1, 6-2, . . . , 6-n) (n=1, 2, 3, . . . ), which are independent from each other.

Here, for the sake of clarity in illustration, the same picture is used to indicate each of the large retail stores 5 in the drawing; however, the large retail stores 5 include, for example, department stores, store location rental businesses, and large-scale distribution industries.

The general companies 6 are also each indicated by the same picture for the sake of clarity in illustration; however, the general companies 6 include wholesale companies, general retail stores, private shops, product manufacturing factories, nonstore-type private vendors, and the like.

As with the domestic membership-system 3, the foreign membership-system 4 is composed of a plurality of large retail stores 7 (7-1, 7-2, . . . , 7-p) (p=1, 2, 3, . . . ) and general companies 8 (8-1, 8-2, . . . , 8-q) (q=1, 2, 3, . . . ), which are independent from each other.

Also in this case, the large retail stores 7 also include, for example, department stores, store place rental businesses, and large-scale distribution industries. The general companies 8 also include wholesale companies, general retail stores, private shops, product manufacturing factories, nonstore-type private vendors, and the like.

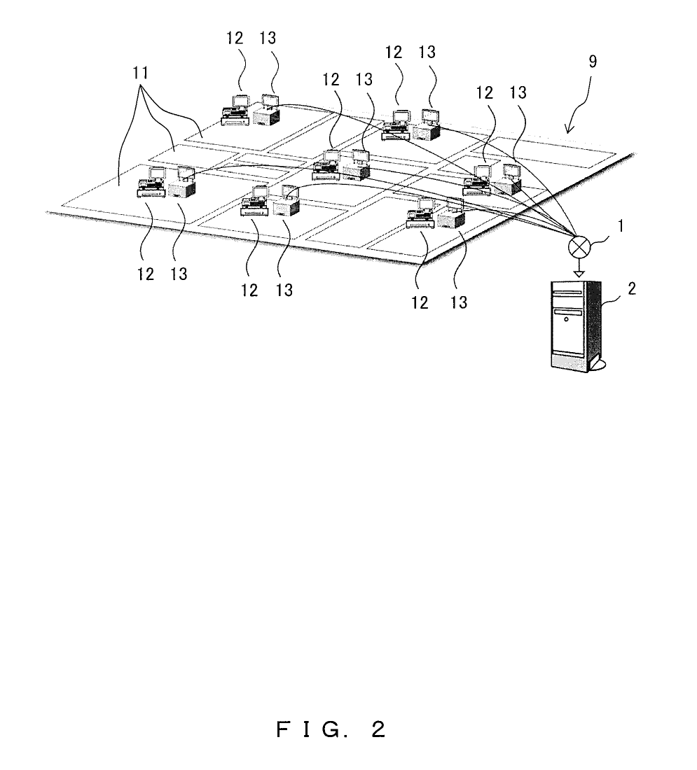

FIG. 2 shows a representative configuration example on a floor surface 9 of one floor of the large retail store 5 or 7 (hereinafter simply referred to as the large retail store 5).

The floor surface 9 may be on any of a plurality of underground floors and a plurality of ground floors. Irrespective of which floor the floor surface 9 on one floor of the large retail store 5 is located on, the floor surface 9 includes a plurality of sectioned sales spaces 11.

Tenants who have made a tenant contract with the large retail store 5 open a store within the sales spaces 11. A cash register (hereinafter referred to as a POS register) 12 is provided at a counter of each of the sales spaces 11 as a product information recording device lent from the large retail store 5 side. Note that “POS” of the term “POS register” is short for “Point of Sale”.

A terminal communication device 13 connected to the system server 2 via the radio communication network 1 is provided proximate to the POS register 12, and this will be described in detail hereafter.

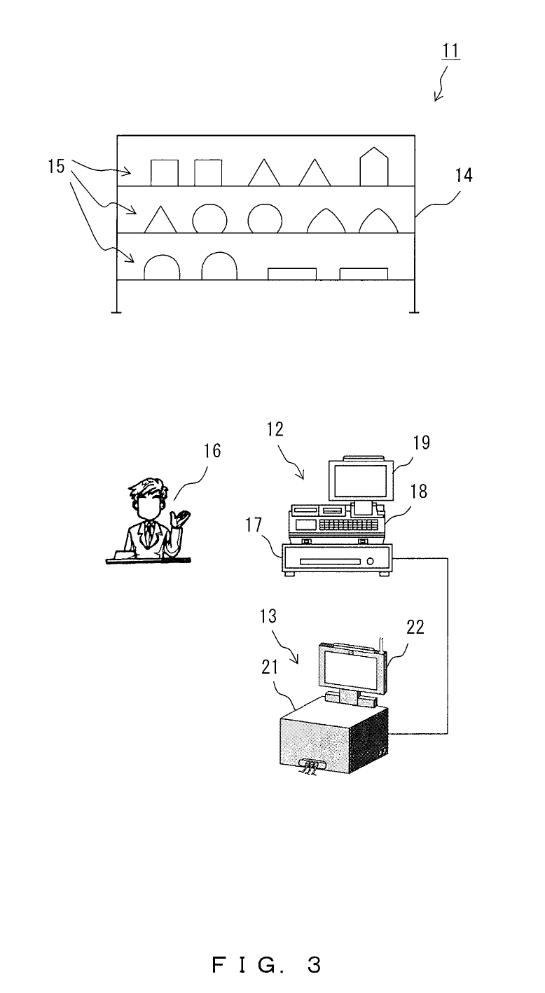

FIG. 3 is a diagram schematically showing the configuration in the sales space 11. As shown in FIG. 3, in the sales space 11, many kinds of products 15 are displayed on product display shelves 14 in an orderly manner. Products for restocking the products 15 are stored in a stock room of the sales space 11.

The products 15 may be pieces of furniture displayed directly on the floor, jewelry and precious metals displayed within a locked glass case, or fresh foods displayed on a shelf provided with a cooling function.

In the sales space 11, there is a salesperson 16 typically called a store clerk and dedicated to this sales space, and she/he explains the product 15 to a customer (hereinafter also referred to as a “purchaser”) who comes to purchase the product 15 and also deals with payment for the product 15.

A POS register 12 essential for the sales space 11 shown in FIG. 2 is provided at a cash desk at which a purchased product is paid for. In the vicinity of the POS register 12, the terminal communication device 13 is provided in, for example, a place such that customers cannot easily see this device, and the terminal communication device 13 plays a main role in the terminal side of the system.

The POS register 12 is provided with: a POS register body device 17 in which a control device and a storage device are embedded; a POS register accounting unit 18 provided with input keys; and a POS register display device 19 composed of a liquid crystal panel and the like, wherein the liquid crystal panel displays the name of a purchased product, an input value, and the total price.

The terminal communication device 13 is provided with: a terminal body device 21 in which a control device and a storage device are embedded; and a terminal display device 22 composed of a liquid crystal panel or the like.

The terminal communication device 13 is connected to the POS register 12 in a wired fashion (wirelessly is also acceptable). The terminal body device 21 is configured so that many kinds of information input terminals are connectable to it, and these information input terminals will be described in detail hereafter.

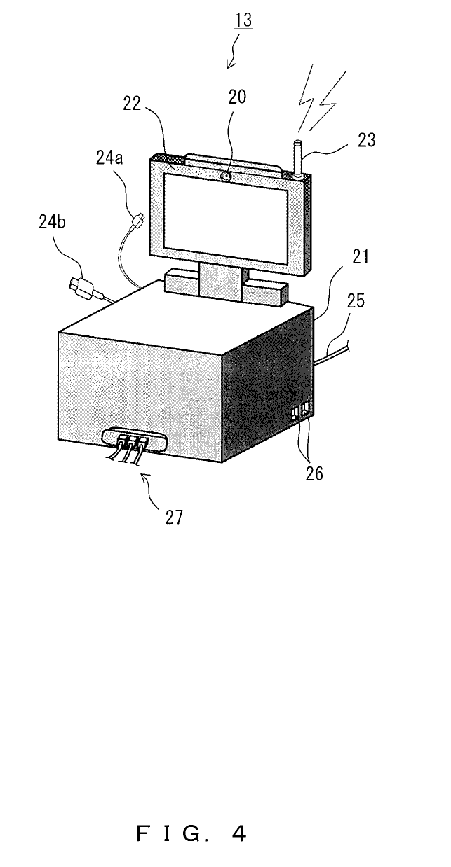

FIG. 4 is a diagram showing details of the configuration of the terminal communication device 13. As shown in FIG. 4, the terminal display device 22 of the terminal communication device 13 has attached to it an antenna 23 for wireless communication with the system server 2. A display-frame-embedded digital camera 20 is provided at an upper portion of the display frame of the terminal display device 22.

Although the display-frame-embedded digital camera 20 is also used to shoot an image of a product, it is mainly used for face-to-face sales to a purchaser who wishes to purchase a product presented for sale at a virtual store.

In regard to virtual stores, materials for presented products and the size of clothes and footwear are unclear. The sales clerk 16 explains, to a purchaser in a face-to-face manner via the display-frame-embedded digital camera 20, points that are unclear from such an image alone.

The terminal body device 21 is provided with a plurality of input-output terminals 24 (24a, 24b) to which a portable telephone, an electronic note, or the like can be connected; a connecting wire 25 to be connected to a code-issuance machine and a reader of product codes; and a plurality of USB ports 26 to be connected to data cards and data disks such as SD, DVD, and CD-R.

In addition, the terminal body device 21 is provided with a plurality of wired ports 27 to be connected to a personal computer, a digital-signage OEL, a telephone, a fax machine, and the like.

The terminal body device 21 has embedded in it: communication devices having a communication facility for dealing with communications, such as Bluetooth, Blu-ray, and wireless LAN; a language translating machine which is used when an attempt is made to present a product for sale at a virtual store of another country; and the like (these elements are not particularly shown).

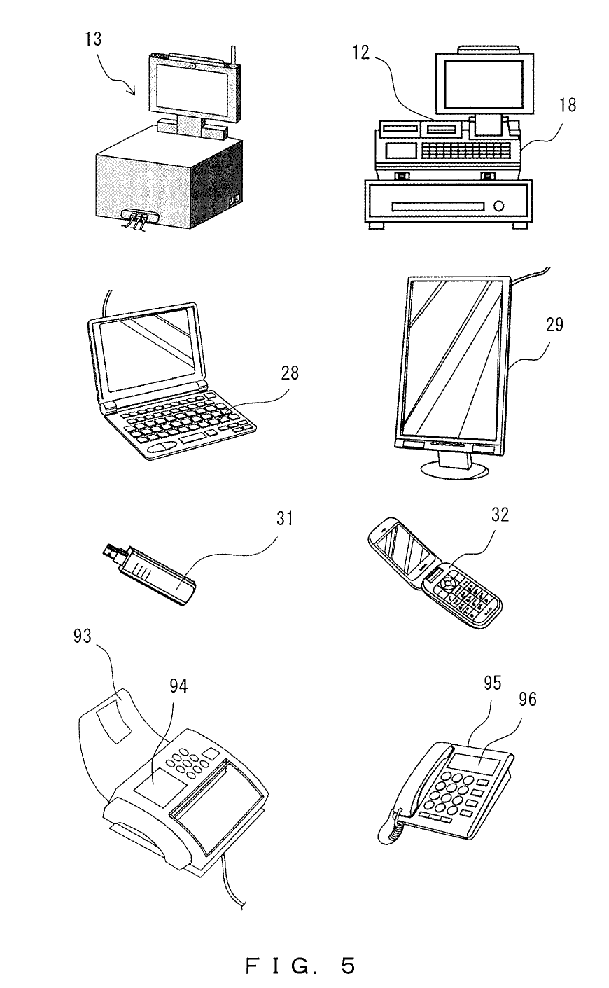

FIG. 5 is a diagram showing some examples of an input device which is used at the cash desk in the sales space 11 by the sales clerk 16 shown in FIG. 3 as a sales-clerk-side input terminal for inputting product information of a product to be presented for sale at a virtual store on the internet, in order to transmit the product information to the system server 2.

All pieces of product information are transmitted to the system server 2 via the terminal communication device 13, and the product information is input to the terminal communication device 13 via the various connections shown in FIG. 5.

As an example, a desired product from among products registered in advance is input and designated using the input keys of the POS register accounting unit 18 of the POS register 12, the product information of the input and designated product is read by a register information reading unit of the terminal communication device 13, and information indicating that the input and designated product is used as both a product for an over-the-counter sale and a product for sale at a virtual store is transmitted to the system server 2.

The sales clerk 16 may input product information in advance using a personal computer 28 and connect the personal computer 28 to the terminal communication device 13 at an appropriate time, with the result that the product information entered in advance is read by the terminal communication device 13.

When the product information corresponds to a new product for over-the-counter sale, it is transmitted from the terminal communication device 13 to the POS register 12. When the product information corresponds to a product presented for sale at a virtual store, it is transmitted from the terminal communication device 13 to the system server 2 as information indicating that this product is used as both a product for over-the-counter sale and a product for sale at a virtual store.

In the meantime, similarly, the sales clerk 16 may input product information in advance using a digital-signage OEL 29, and she/he may connect the digital-signage OEL 29 to the terminal communication device 13 at an appropriate time so as to cause the terminal communication device 13 to read the product information input in advance, with the result that processes may be performed as with the case of the personal computer 28.

As another example, product information input using the personal computer 28 maybe stored in a USB type flash memory 31 in advance, and the memory 31 may be connected to the terminal communication device 13 at an appropriate time so as to cause the device 13 to read the product information input in advance, with the result that processes maybe performed as with the case in the situation in which the product information is input directly from the personal computer 28.

Using, for example, a mail service function which a portable telephone 32 has, product information to which a product image file reserved by mail in advance is attached may be transmitted, as product information of a product to be presented for sale at a virtual store, to the product terminal communication device 13 via, for example, a USB terminal or Bluetooth communication.

An electronic device having a function for dealing with an image as electronic data electrically communicates, to the system server 2, product information composed of, for example, a product image displayed on a display screen 94 of a facsimile machine 93 and information input via key inputs and not including an image. Alternatively, product information composed of a product image displayed on a display screen 96 of a telephone 95 and information input via key inputs and not including an image is transmitted via mail.

The product image above is an image of the product 15 shot by the sales clerk 16 using the portable telephone 32 and transferred to the facsimile machine 93 or the telephone 95. In either case, the sales clerk 16 selects a system with which processes can be performed quickly and then transmits the product information to the system server 2.

The product information described above includes at least information for identifying a sales space of the product presenter, information for identifying the product name, an image of the product, the current number of the product in stock, the sales price of the product, and the like.

These pieces of information are encoded and a product code ticket is then issued by a code-issuance machine, and the product code ticket is attached to the product. When the product is sold, the code in the product code ticket attached to the product is read by a reader so as to input this code in the POS register 12 directly or via the terminal communication device 13.

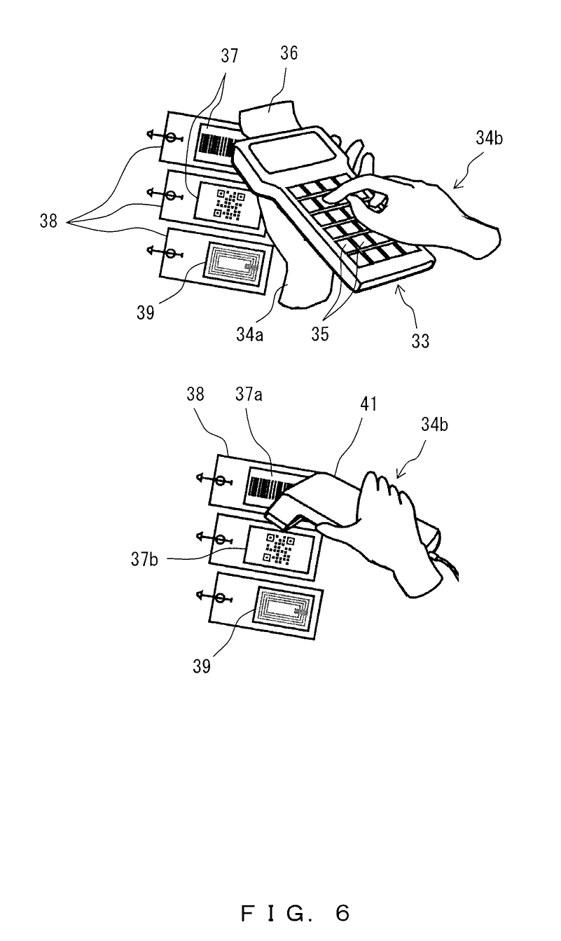

FIG. 6 is a diagram showing a code-issuance machine for issuing a product code ticket and a reader for reading the product code ticket. While the sales clerk 16 shown in FIG. 3 is holding a code-issuance machine 33 shown on the upper side of FIG. 6 with, for example, her/his left hand 34a, she/he inputs product information by pressing input keys 35 of the code-issuance machine 33 with her/his right hand 34b, with the result that a product code 37 is printed and output on, for example, a rolled paper sheet 36 whose backside is glued and to which a backing sheet is attached, the product code 37 being composed of a two-dimensional code, such as a barcode, which indicates product information.

A backing sheet is removed from the product code 37 which has been printed and output, and the product code 37 whose backside is glued is stuck on a price tag 38 and the price tag 38 is then attached to the product.

An IC tag 39 is also stuck on the price tag 38; however, the IC tag 39 is usually prepared in advance by the wholesaler, and hence it is usually incorporated in advance at an unnoticeable portion of the product in many cases.

Accordingly, the IC tag 39 cannot be issued by the code-issuance machine 33; however, FIG. 6 shows an example in which the IC tag 39 may be stuck on the price tag 38.

When the sales clerk 16 traces the product code 37 (a barcode 37a, a two-dimensional code 37b) stuck on the price tag 38 with a reading part of a reader 41 shown on the lower side of FIG. 6 for reading a product code ticket while she/he is holding the reader 41 with, for example, her/his right hand 34b, the product code 37 is read and input to the terminal communication device 13 via the connecting wire 25 shown in FIG. 4.

The reader 41 has an RFID (radio frequency identification) system embedded in it, and it may read product information in the IC tag 39 by exciting a receiving antenna of the IC tag 39.

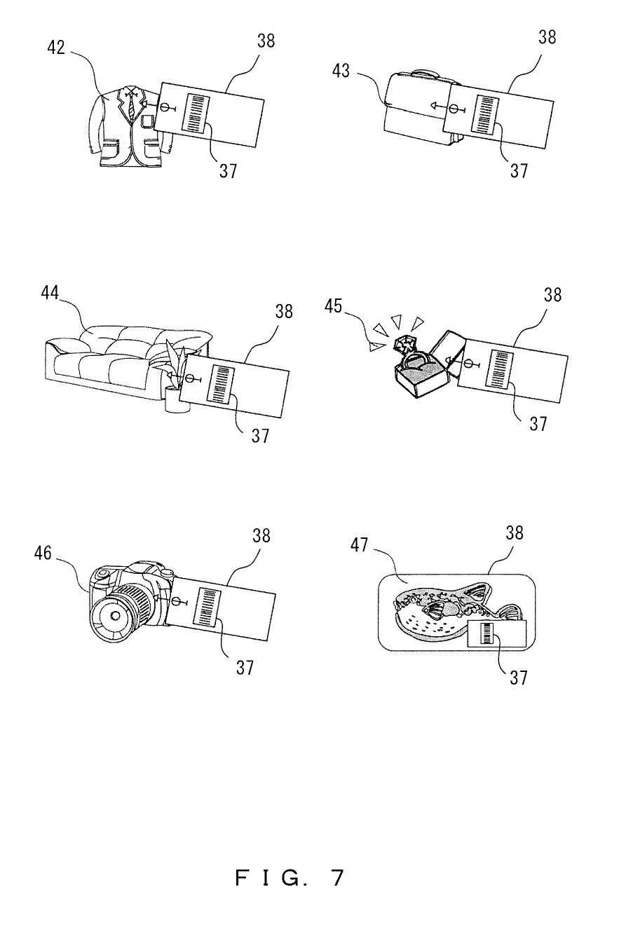

FIG. 7 is a diagram showing, as references, examples of products to which the price tag 38 is attached, wherein the product code 37 issued as described above is stuck on the price tag 38.

FIG. 7 shows a men's coat 42 as an example of clothing, a bag 43 as an example of a leather product, a sofa 44 as an example of furniture, a ring 45 as an example of jewelry or precious metals, a single-lens reflex electronic camera 46 as an example of portable electronics, and a fish 47 as an example of a fresh food, wherein these elements are ordered from the upper side to the lower side in FIG. 7.

In the price tag 38 shown in FIG. 7, only the product code 37 is shown as an example of the product code; however, instead of the product code 37, the IC tag 39 shown in FIG. 6 may be attached to a product that is particularly small and expensive, such as the ring 45.

The examples of the products shown in FIG. 7 are exclusive to over-the-counter sales at the sales space 11, and hence the price tag 38 is attached to them; however, when these products are sold at a virtual store in the radio communication network 1 via the system server 2, product codes are issued, and these product codes indicate that those products are inventory products for sale at both the sales space and the virtual store or that they are inventory products exclusive to sales at the virtual store.

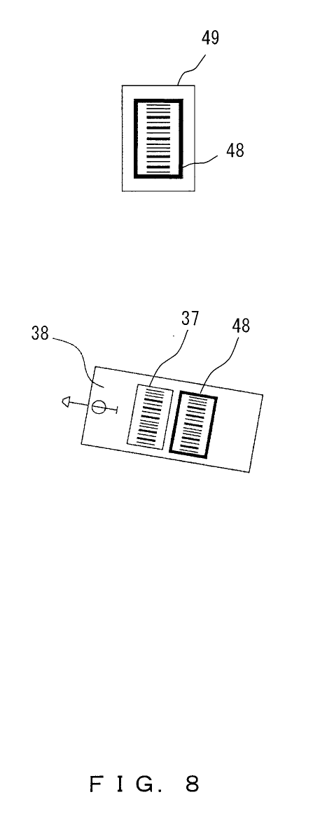

An example of a product code for a virtual store (i.e., a code for both a sales space and a virtual store or a code exclusive to the virtual store) issued by the code-issuance machine 33 is shown on the upper side of FIG. 8, and the usage of this product code is shown on the lower side of FIG. 8.

After a backing sheet 49 is removed from the virtual-store product code 48 shown on the upper side of FIG. 8, the code 48 is stuck on the price tag 38 next to the sales-space product code 37 which has already been stuck on the price tag 38, as shown on the lower side of FIG. 8.

Virtual-store products include products whose inventory is used for sales at both a sales space and a virtual store and products whose inventory is exclusively for sales at the virtual store.

An inventory product exclusive to sales at a virtual store here is, for example, a product that is selected as a clearance product at a sales space, and a product code and a price (a clearance price) which are different from those for the sales space are set for it. The inventory of such a set clearance product is managed separately from the inventory of products for the sales space.

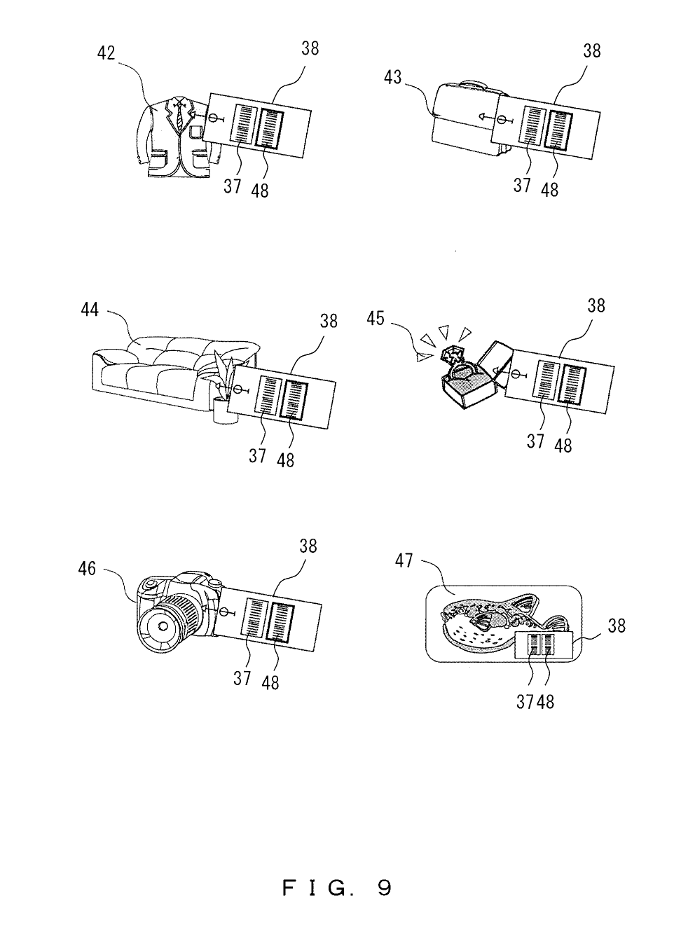

FIG. 9 is a diagram showing a situation in which the price tag 38 is attached to the various products shown in FIG. 7 as examples of sales products, wherein the sales-space product code 37 and the virtual-store product code 48 which are next to each other are attached to the price tag 38.

The virtual-store product code 48 is read by the reader 41 together with the sales-space product code 37, and they are transmitted to the system server 2 via the terminal communication device 13.

Also, in the price tag 38 shown in FIG. 9, only the product code 37 is shown as an example of the product code; however, instead of the product code 37, the IC tag 39 shown in FIG. 6 may be attached to a product that is particularly small and expensive, such as the ring 45.

When an attempt is made to sell a product for sale at a sales space as a product for sale at a virtual store as described above, processes to be performed on the sales space 11 side (i.e., the sales clerk 16 side) are completed by merely issuing the virtual-store product code 48 using the code-issuance machine 33 and sticking it on the price tag 38.

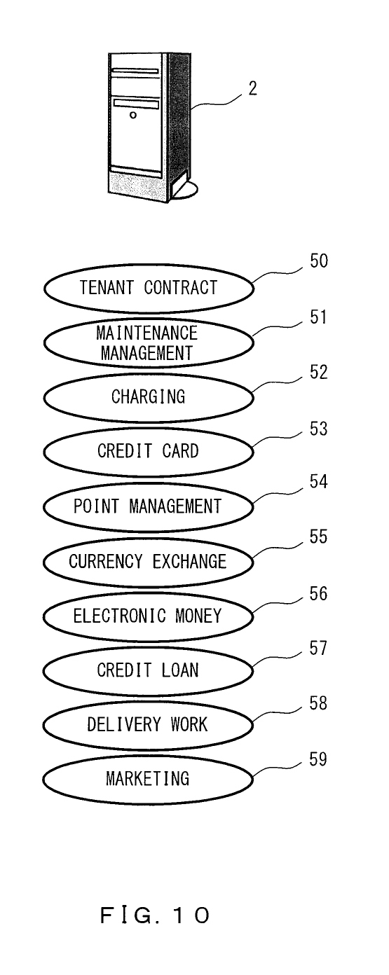

FIG. 10 is a diagram illustrating processing functions of the system server 2 which receives an offer to present a product currently presented at the sales space 11 as a product for sale at a virtual store.

As shown in FIG. 10, the system server 2 has, as shown below it in FIG. 10, processing functions such as a tenant contract function 50, a maintenance management function 51, a charging function 52, a credit card function 53, a point management function 54, a currency conversion function 55, an electronic money function 56, a credit loan function 57, a delivery work function 58, and a marketing function 59.

The tenant contract function 50 is a function for receiving an offer to present a product for sale at a virtual store and for receiving the product information, wherein the offer is an offer received via the terminal communication device 13 from the sales clerk 16 of the large retail store 5 or 7 or the general company 6 or 8 registered as a member.

On the basis of the product information received by the tenant contract function 50, the maintenance management function 50 has a function for setting the sales space of the product presenter as a predetermined region and opening a virtual product, and it has a function for showing, in the virtual store, at least the product name, the code data, the product image, the number of the product currently in stock, the sales price, and the explanation of the product.

In addition, the maintenance management function 51 has a function for, when a Web purchaser decides to purchase a product, recording the sales volume and the sales unit price in a database and reporting, to the product presenter of the product, the payment procedure for the payment.

The charging function 52 is a function for, when a Web purchaser decides to purchase a product, recording, in a database, the charge amount and a payment method for the Web purchaser on the basis of the sales volume and the sales unit price of this purchased product and for collecting the payment in accordance with the payment method.

The credit card function 53 is a function for, when the payment method of the Web purchaser recorded by the charging function 52 is a payment using a credit card, reporting, to the credit card company, a credit card number and other pieces of information which have been reported to the system server 2 via the charging function 52 by the Web purchaser, and for making a request for the credit card company to pay for the purchased product on behalf of the Web purchaser and arranging a payment to the product presenter.

The point management function 54 has a function for, when a product presented for sale at a virtual store is purchased by a Web purchaser, giving a predetermined number of points to the Web purchaser and the product presenter (sales clerk).

In addition, the point management function 54 has a function for reporting, to the Web purchaser and the product presenter (sales clerk), new points and cumulative points (if any) or only new points in the absence of any cumulative points.

The currency conversion function 55 has a function for, when the product presenter and the Web purchaser currently live in different countries, giving notice to the maintenance management function 51 such that it converts, on the basis of the present exchange rate, the price of the product exhibited at the virtual store from the price represented by the currency of the country of the product presenter into the price represented by the currency of the country of the virtual store, and to display the converted price.

In addition, the currency conversion function 55 has a function for, when an exhibited product is purchased, converting the currency of the country of the virtual store used for the payment into the currency of the country of the product presenter on the basis of the present exchange rate and for giving notice to the product presenter such that they perform a payment procedure.

The electronic money function 56 has a function for, when the payment method of the Web purchaser recorded by the charging function 52 is a payment using electronic money, withdrawing the money for the payment of the Web purchaser from an electronic money account reported to the system server 2 by the Web purchaser via the charging function 52 and for giving notice to the maintenance management function 51 such that the product presenter performs a payment procedure using a predetermined method.

The credit loan function 57 has a function for, when the payment method of the Web purchaser recorded by the charging function 52 is a credit loan, reporting to a credit loan company (usually the same as the credit card company) the information reported to the system server 2 by the Web purchaser via the charging function 52 that a new credit loan has been brought about.

In addition, the credit loan function 57 has a function for making a request to pay for a product on behalf of the purchaser on the basis of the loan contract and for giving notice to the maintenance management function 51 such that it arranges the payment to the product presenter.

The delivery work function 58 is a function for, when it is determined that a Web purchaser has purchased a product exhibited at a virtual store, giving notice to the sales clerk 16, via the terminal communication device 13 of the sales space 11 which presents the product for sale at the virtual store, such that she/he packs the product in a packing mode suitable for transport to the location of the Web purchaser and sends it to the Web purchaser immediately, wherein the notice is given using mail, fax, or the like.

The marketing function 59 has a function for accumulating, in a database, sales data, such as the product name, sales volume, sales unit price, and the product presenter of the product registered for sale at the virtual store and determined to be purchased by the Web purchaser, the portal site of the virtual store which has sold the product, and the location of the Web purchaser.

In addition, the marketing function 59 has a function for setting, in accordance with sales data of a product that sells well, the product name, the sales volume (the amount of prepared inventory), sales unit price, and the product presenter of the products corresponding to the product to be presented for sale at the virtual store in the future and to be preferentially promoted, the portal site of the virtual store which has sold the product, the location of the Web purchaser, or the like, and for reporting the set data to the tenant contract function 50.

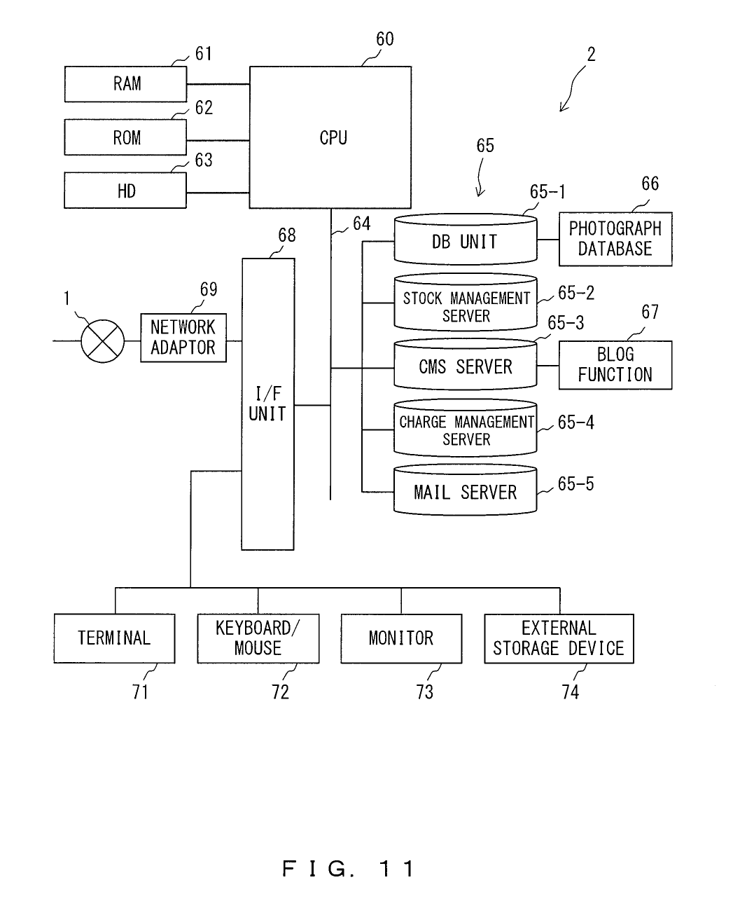

FIG. 11 is a block diagram showing a system configuration of the system server 2 provided with the aforementioned functions. As shown in FIG. 11, the system server 2 is provided with a CPU (a central processing unit) 60.

A ROM (a read only memory) 62, a RAM (a Random Access Memory) 61, and an HD (a hard disk) 63 are directly connected to the CPU 60. In addition, a storage unit 65 is connected to the CPU 60 via a bus 64, wherein the storage unit 65 is divided into a plurality of regions each of which is managed.

The ROM 62 stores an OS (an operating system). The HD 63 stores a system program with which the CPU 60 controls the tenant store sales promotion management system. The RAM 61 is divided into a program region and a data region.

A program needed for processing at that moment in the system program is read from the HD 63 and then stored in the program region. Data on a final result and data on a non-final result computed by the CPU 60 are temporarily stored in the data region.

A DB (data-base) unit 65-1, an inventory management server 65-2, a CMS (Content Management system) server 65-3, a charge management server 65-4, and a mail server 65-5 are stored in the respective regions of the storage unit 65.

The DB unit 65-1 is provided with a photograph database region 66 for storing large-recording-capacity shot image data (including moving images) transmitted from, in particular, the sales clerk side via a portable telephone, the display-frame-embedded digital camera 20, or the like.

The portable telephone or the display-frame-embedded digital camera 20 on the sales clerk side is not only used to shoot the image of a product but also used for face-to-face sales through an internet television communication using shot moving images.

The inventory management server 65-2 updates the number of products in stock from among the product information stored in the DB unit 65-1 in accordance with the sale of a product.

The CMS server 65-3 performs processes in accordance with the usage of a product presented for sale at a virtual store and the original function for administrating and managing the virtual store, and it is also provided with a blog function 67.

The charge management server 65-4 cooperates with the CAFIS via the radio communication network 1 and collects the payment and the service fee from a purchaser of a product presented for sale at the virtual store.

The mail server receives a mail transmitted from the sales clerk 16 or a purchaser via a portable telephone, a personal computer, a FAX machine, a home telephone, or the like, and it reports, to each server, product information obtained by analyzing the content of the mail.

In addition, an I/F (interface) unit 68 is connected to the CPU 60 via the bus 64. A network adaptor 69 is connected to the I/F unit 68. The CPU 60 communicates with the radio communication network 1 through the network adaptor 69 and the I/F unit 68.

As described above, the domestic membership-system 3, the foreign membership-system 4, and the CAFIS having a specific contract with the system administration company of the system server 2 are connected to the radio communication network 1.

Using the data of the DB unit 65-1, each of the aforementioned servers (65-2 to 65-5) performs, under the control of the CPU 60, a process shared with the terminal communication device 13 which serves as a client of the domestic membership-system 3 or the foreign membership-system 4.

In particular, the charge management server 65-4 also cooperates with the CAFIS.

A terminal 71, a keyboard/mouse 72, a monitor 73, and an external storage device 74 are connected to the I/F unit 68. The system manager uses the terminal 71 by connecting various terminal devices to it in order to input or output data.

The system manager uses the keyboard/mouse 72 in order to operate an instruction input.

The monitor 73 is a man-machine interface between the system manager and the CPU 60.

The system manager uses the external storage device 74 by detachably equipping it with various mass storage devices in order to back up important data.

The CPU 60 uses the aforementioned configurations to construct the functions shown in FIG. 10 and performs processes in accordance with the functions.

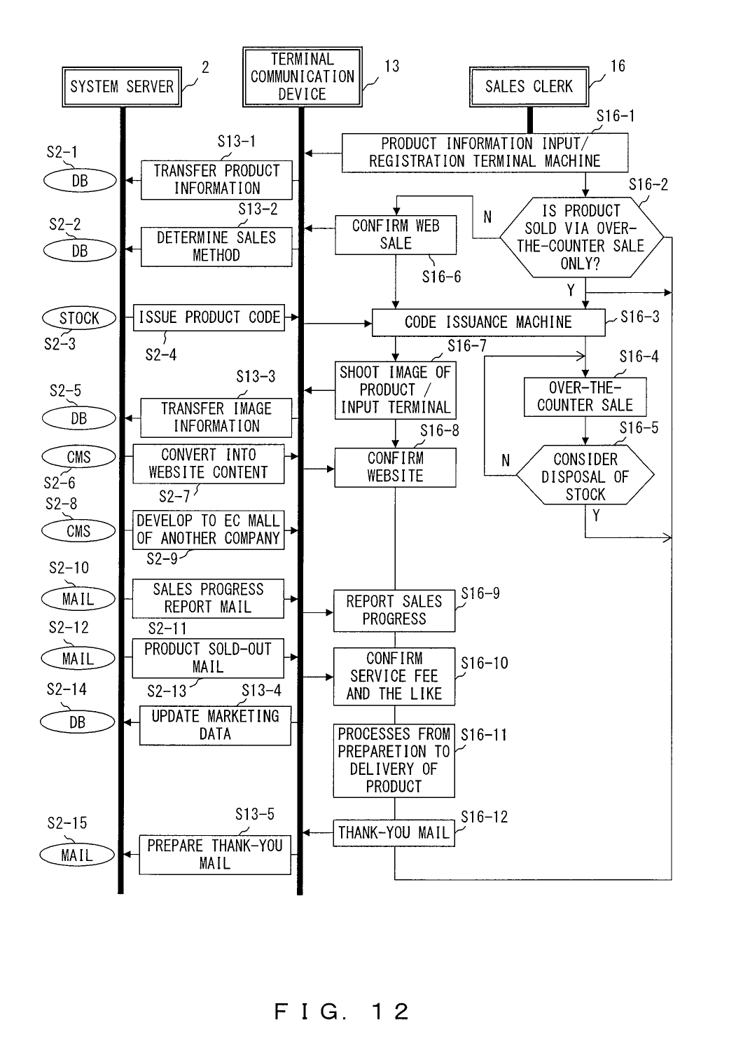

FIG. 12 is a flowchart illustrating a process operation by the terminal communication device 13 and a process operation by the system server 2, the process operations being based on a decision making of the sales clerk 16 who manages products at the sales space 11 and a virtual store and the sale of the products.

First, the sales clerk 16 uses the POS register 12 (see FIG. 3), which functions as a product information input/registration terminal machine, so as to input product information of a product presented for sale at the sales space 11, with the result that the present state of the product is registered or updated (step S16-1).

As a result, product information of all products sold commonly at the sales space 11 and in the virtual store is recorded in the POS register 12 at the sales space 11, the product information including the product names, the prices, and the number of the products currently in stock.

When the terminal communication device 13 reads the product information from the POS register 12, it adds, to the information, information for identifying the sales space 11 so as to generate product information addressed to the virtual store and transmits the generated product information to the system server 2 (step S13-1).

The system server 2 stores the received product information in the DB unit 65-1 (step S2-1).

Next, for each of the products currently registered in the POS register 12, the sales clerk 16 thinks about whether or not the product should be sold only at the sales space 11 without selling it at the virtual store (step S16-2).

When the sales clerk 16 wishes to only sell a product at the sales space 11 (Y in S16-2), the process returns to step S16-1 and, although not shown in particular, the product code is input using the input keys of the POS register 12 and a “No” button is pressed.

The pressing of the “No” button is the indication of the intention of the sales clerk 16 that the product will not be presented for sale at the virtual store.

The terminal communication device 13 reads the product code and the “No” information from the POS register 12 and transmits the read information to the system server 2 as information indicating that a “No” sales method has been settled upon (step S13-2).

In this case, the system server 2 deletes the product information of the product code from the DB unit 65-1 (step S2-2).

Subsequent to the pressing process of the “No” button, the sales clerk 16 issues a product code 37 of the product using the code-issuance machine 33 (see FIG. 6) (step S16-3).

Then, the issued product code 37 is stuck on the price tag 38, the card is attached to the product (see FIG. 7), and the product is displayed on the product display shelves 14 and sold at the store as a product 15 for over-the-counter sales (step S16-4).

After a passage of a certain period, the sales clerk 16 checks the sale of the product 15 and thinks about whether the disposal of the inventory should be considered or not (step S16-5).

When the sales clerk 16 does not think that the disposal of inventory is needed (N in S16-5), she/he continues the over-the-counter sales (step S16-4).

By contrast, when the sales clerk 16 thinks that the disposal of the inventory should be considered (Y in S16-5), she/he inputs, to the POS register 12, the product code and the markdown unit price of the product (step S16-1).

The disposal of inventory is a special price sale (a low price sale) performed only at the virtual store. The number of products in inventory registered in the POS register 12 and common to the sales space 11 and the virtual store for the product is not changed.

The terminal communication device 13 reads the product information for the special sale of the POS register 12 and transmits, to the system server 12, information indicating that a sales method of a “special sale” has been settled upon (step S13-2).

In this case, the system server 2 stores the product information in the DB unit 65-1 as product information of a product newly presented for sale at the virtual store (step S2-1).

Meanwhile, after the sales clerk 16 initially inputs the product information in step S16-1, when she/he thinks that the product should not only be sold at the sales space 11 but should also be sold at the virtual store in parallel, there are no further data inputs.

When the “No” button is not pressed, the terminal communication device 13 determines that the sale at the virtual store (hereinafter referred to as a Web sale) has been confirmed (step S16-6), and it transmits the product information of the product to the system server 2 as the information indicating that a “Yes” sales method has been settled upon (step S13-2).

The product information includes: information for identifying at least the sales space 11; information on the product name; image data of the product; data on the sales unit price; and information on the total number of products in stock, which is the combination of the number of the products 15 on the product display shelves 14 in the sales space 11 and the number of the products 15 in the restocking of the inventory storage location of the sales space 11.

In this case, the system server 2 stores the product information in the DB unit 65-1 as product information of a product newly presented for sale at the virtual store (step S2-2).

The DB unit 65-1 extracts the image data in the product information, links it to the product information, and then stores the information in the photograph database 66.

The inventory management server 65-2 of the system server 2 starts managing the inventory of the product on the basis of the product information (step S2-3), and it generates a product code of the product for the virtual store and issues it to the terminal communication device 13 (step S2-4).

Using the code-issuance machine 33 connected in advance, the terminal communication device 13 issues the product code issued from the system server 2 (step S16-3).

When the code-issuance machine 33 is not connected in advance to the terminal communication device 13, the product code is displayed on the terminal display device 22 and an instruction to issue the product code is given to the sales clerk 16. The product code issued here is the virtual-store product code 48 shown in FIG. 9.

Subsequent to the issuance of the virtual-store product code 48, the sales clerk 16 shoots the image of the product and inputs the image data in the terminal communication device 13 (step S16-7).

The product image data may be data obtained by shooting the image of the product using the portable telephone 32 or may be data obtained by shooting the image of the product using a digital camera in advance and then stored in the personal computer 28, the USB type flash memory 31, or the like.

The terminal communication device 13 transfers, to the system server 2, image data of the product which is information added to product information corresponding to the virtual-store product code 48 issued in advance (step S13-3).

The system server 2 stores, in the photograph database region 66 of the DB unit 65-1, the image data transferred from the terminal communication device 13 (step 2-5).

Next, the system server 2 controls the CMS server 65-3 (step S2-6) to convert the product information and product material data into a mode for display at the virtual store for the Web site and transmits the converted data to the terminal communication device 13 (step S2-7).

The conversion above is a conversion into a product development content using, for example, an HTML document or an XML document.

The terminal communication device 13 receives the converted data and displays, on the terminal display device 22, a display mode of the product exhibited at the virtual store of the Web site, and the sales clerk 16 performs key input to indicate that the displaying has been confirmed (step S16-8). The input of the confirmation is reported from the terminal communication device 13 to the system server 2.

The system server 2 again controls the CMS server 65-3 (step S2-6) to present the product for sale at a virtual store of another company which is a business partner by using the product development content of the product (step S2-9).

When it is determined that the purchaser 80 purchases the product 15 presented for sale at the virtual store, the system server 2 controls the mail server 65-6 (step S2-10) to transmit a sales progress report mail to the terminal communication device 13 (step S2-11).

The terminal communication device 13 displays, on the terminal display device 22, a sales progress report which is the content of the mail received from the mail server 65-5 of the system server 2, and it updates the product information stored in the POS register 12 on the basis of the content of the sales progress report (step S16-9).

When the purchases of the products 15 presented for sale at the virtual store by the purchasers 80 make satisfactory progress and all the products 15 at the sales space 11 and the virtual store are sold out, the system server 2 controls the mail server 65-5 (step S2-12) to transmit, to the terminal communication device 13, a mail indicating that the products have been sold out (step S2-13).

This product sold-out mail also includes data on the handling fees and the like for the virtual store.

The terminal communication device 13 displays, on the terminal display device 22, the content of the product sold-out mail received from the mail server 65-5 of the system server 2 and updates the product information stored in the POS register 12 on the basis of the content of the product sold-out mail, and the sales clerk 16 confirms the content of the product sold-out mail displayed on the terminal display device 22 as well as the service fee (step S16-10).

Upon the selling out of the product 15, the terminal communication device 13 gives notice to the system server 2 such that it updates the data on the marketing (step S13-4).

On the basis of the notice, the system server 2 deletes the product information of the product in the DB unit 65-1 and reports to the CMS server 65-3 that the product information has been deleted because it is sold out (step S2-14).

Meanwhile, when the sales clerk 16 sees a sales progress report based on the sales progress report mail or when she/he sees a sold-out product, service fee, or the like based on the product sold-out mail, then, on the basis of this check, she/he arranges for the posting of the product which the purchaser 80 has determined to purchase (step S16-11).

Next, using the personal computer 28, the facsimile machine 93, the portable telephone 32, or the like, the sales clerk 16 inputs a “thank-you mail” to the terminal communication device 13 as a token of gratitude for the sale of the product presented for sale at the virtual store (step S16-12).

The terminal communication device 13 transmits the input “thank-you mail” to the system server 2 (step S13-5). The system server 2 controls the mail server 65-5 to display the content of the “thank-you mail” in the display region of the product within the virtual store for a predetermined period (step S2-15).

Upon the selling out of a certain product, the sales clerk 16 purchases inventory of the product or purchases inventory of a new product and then returns to the procedure of step S16-1.

In the determination in the following step, S16-2, not only products just purchased for inventory but also products already presented for sale at the virtual store may be designated as a non-presented product when the product is desired to be sold via over-the-counter sales only. The remaining processes are the same as those described above.

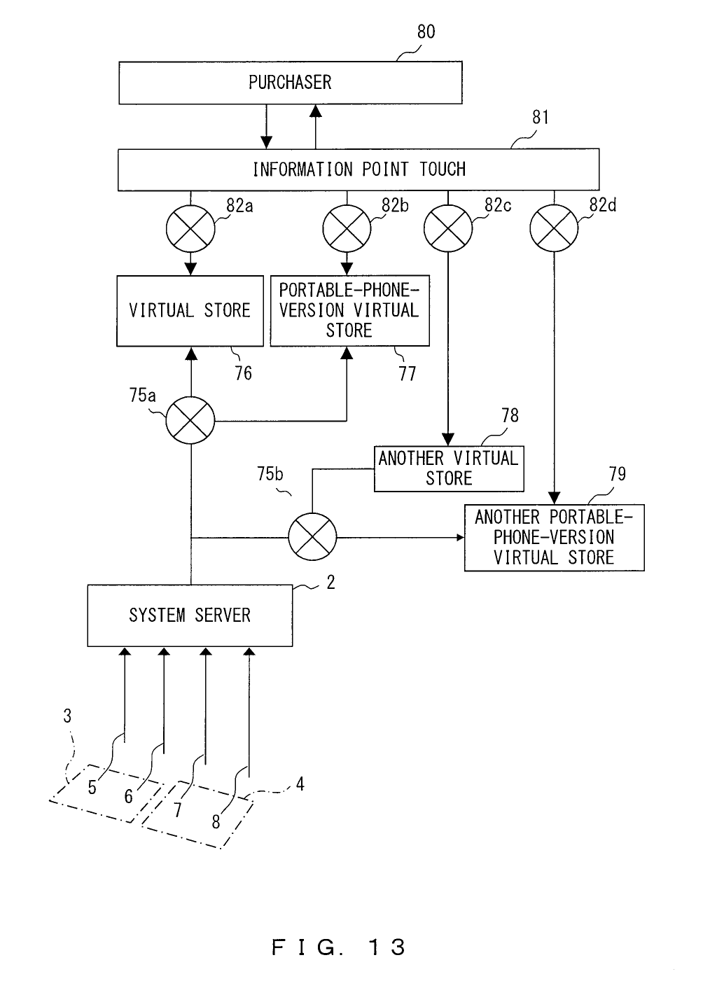

FIG. 13 is a diagram showing a relationship between processes performed on the purchaser side of a product at the virtual store and processes performed on the system server side.

As shown in FIG. 13, the system server 2 displays, on a virtual store 76, a portable phone version virtual store (hereinafter simply referred to as a portable phone virtual store) 77, another virtual store 78, and another portable phone virtual store 79, and the like, the aforementioned common products and clearance products provided by the large retail store 5 and the general company 6 of the domestic membership-system 3 or the large retail store 7 and the general company 8 of the foreign membership-system 4 via virtual store communication networks 75a and 75b.

Using an input terminal device 81 capable of accessing the virtual store, the purchaser 80 accesses virtual store 76, the portable phone virtual store 77, the another virtual store 78, the another portable phone virtual store 79, or the like via providers 82 (82a, 82b, 82c, 82d) and determines to purchase a desired exhibited product by using a pointing device or by directly touching the screen (desired product information/point touch).

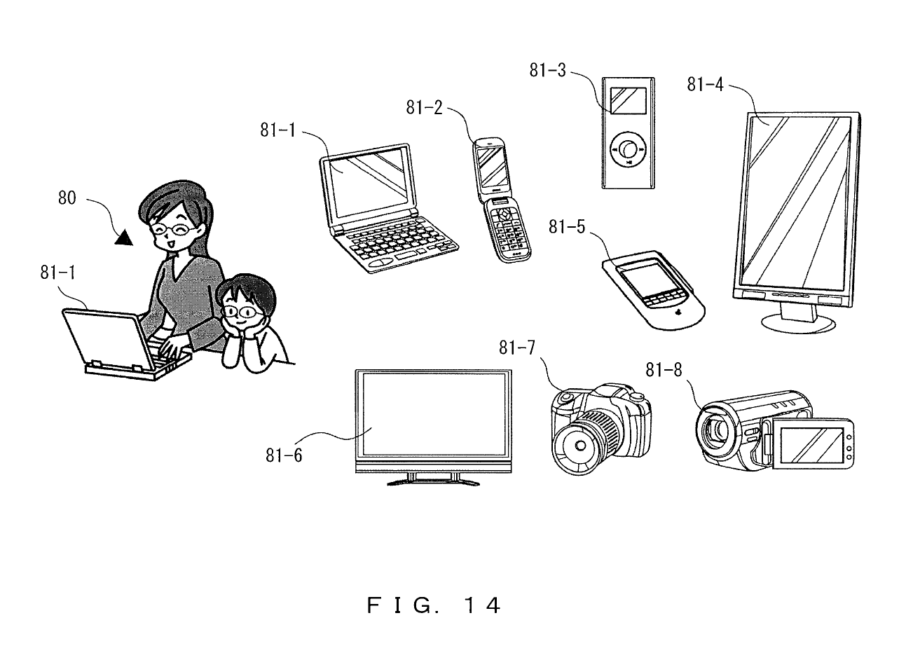

FIG. 14 is a diagram showing examples of various input terminal devices 81 which can be used by a purchaser 80. As shown in FIG. 14, any electronic terminal instrument can be the input terminal device 81 which can be used by the purchaser 80 as long as it can access the internet, it is provided with a display device capable of displaying a desired image, and a touch screen function can be performed on its display.

FIG. 14 shows, as examples, a personal computer 81-1, a portable telephone 81-2, portable audio 81-3, a digital-signage OEL 81-4, a PDA (personal digital assistant) terminal 81-5, a TV 81-6, a digital camera 81-7, a digital movie 81-8, and the like.

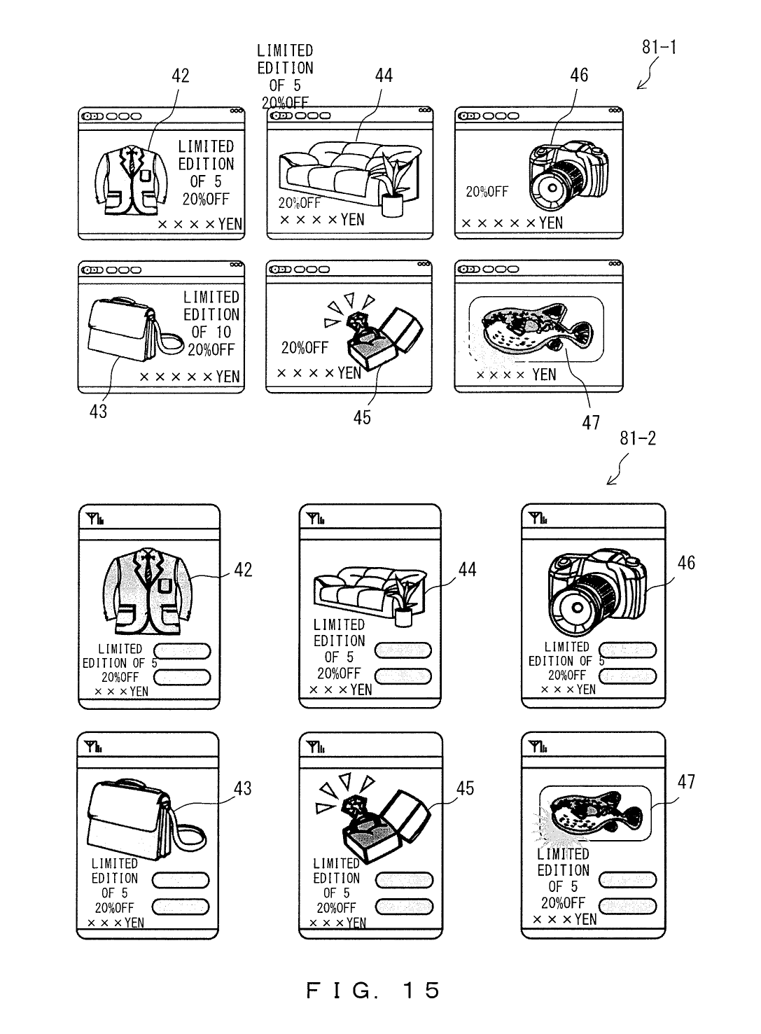

FIG. 15 is a diagram showing examples of exhibited products at the virtual store which are displayed on the display screen of the input terminal device 81 of the purchaser 80. Representative examples displayed on the display screen of the personal computer 81-1 are shown on the upper side of FIG. 15, and examples displayed on the display screen of the portable telephone 81-2 are shown on the lower side of FIG. 15.

Products of the classes shown in FIG. 9 presented from the sales space 11 are displayed on both the upper side and the lower side. For example, the purchaser 80 first designates a desired product class to search for a sales space 11 at which products of the class are presented for sale.

The purchaser 80 then sees the image of a product of the designated product class which is presented for sale. When the purchaser 80 does not like the product, she/he searches for the next sales space 11. When the purchaser 80 likes the product, she/he determines to purchase it by performing a touch screen function on the screen of the product image.

In the meantime, in regard to the aforementioned embodiment 1, the sales space of the large retail store 5 or of the domestic membership-system 3 or the foreign membership-system 4 or the sales space of the general company 6 or 8 was described as an example of the sales space 11 from which a product is presented for sale at the virtual store via the radio communication network 1; however, it was said herein that the general company 6 or 8 may include a wholesale company, a general retail store, a private shop, a product manufacturing factory, or the like as well as a nonstore-type private vendor.

Wholesale companies, general retail stores, private shops, product manufacturing factories, and the like are usually provided with a POS register for product management; however, nonstore-type private vendors do not needed to be provided with a POS register. Product sales are usually managed using a personal computer.

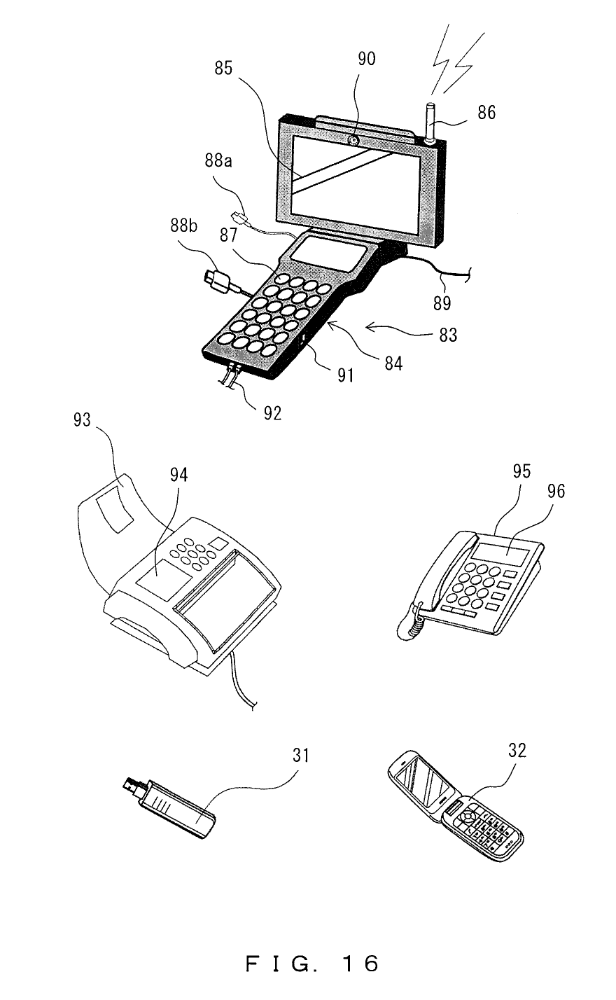

FIG. 16 is a diagram showing a small-size terminal communication device and peripheral instruments which are used by a nonstore-type private vendor in order to present a product for sale, wherein the nonstore-type private vendor is a member of the tenant store sales promotion management system in this example. As shown in FIG. 16, a small-size terminal communication device 83 is composed of a body device 84 and a display device 85.

The display device 85 of the terminal communication device 13 has attached to it an antenna 86 for wireless communication with the system server 2. A display-frame-embedded digital camera 90 is provided at an upper portion of the display frame of the display device 85.

Although the display-frame-embedded digital camera 90 is also used to shoot an image of a product, it is mainly used for face-to-face sales to a purchaser who wishes to purchase a product presented for sale at a virtual store, as with the display-frame-embedded digital camera 20 of the terminal communication device 13 provided at the sales space 11 of the large retail store.

The body device 84 is provided with a plurality of data input keys 87 on its top surface, a connection line 89 on its top for connection to a commercial power supply, and a plurality of input-output terminals 88 (88a, 88b) on one of its side surfaces to which a portable telephone, an electronic note, or the like can be connected.

The body device 84 is provided with, on the other side surface, a USB port 91 to be connected to a data card and a data disk, such as an SD, DVD, CD-R, and flash memory. The body device 84 is provided with, on the near side surface, a plurality of wired ports 92 to be connected to, for example, a personal computer, a PDA terminal, a fax machine, a home telephone, and the like.

Using the small-size terminal communication device 83 and the aforementioned peripheral instruments as appropriate, the nonstore-type private vendor inputs product information composed of at least a product name code, initial inventory quantity data, sales price data, sales volume data, the ID of the vendor, and the like for presenting the product for sale at the virtual store.

An electronic device having a function for dealing with an image as electronic data electrically communicates, to the system server 2, product information composed of, for example, a product image displayed on a display screen 94 of a facsimile machine 93 and information input via key inputs and not including an image. Alternatively, product information composed of a product image displayed on the display screen 96 of the telephone 95 and information input via key inputs and not including an image is transmitted via mail.

The product image above is an image of the product 15 shot by the nonstore-type private vendor using the portable telephone 32 and transferred to the facsimile machine 93 or the telephone 95. In either case, the nonstore-type private vendor selects a system with which processes can be performed quickly and then transmits the product information to the system server 2.

### INDUSTRIAL APPLICABILITY

The present invention may be used for a tenant store sales promotion management system.

### EXPLANATION OF THE CODE

1 Radio communication network
2 System server
3 Domestic membership-system
4 Foreign membership-system
5 (5-1, 5-2, . . . , 5-m) Large retail store
6 (6-1, 6-2, . . . , 6-n) General company
7 (7-1, 7-2, . . . , 7-p) Large retail store
8 (8-1, 8-2, . . . , 8-q) General company
9 Floor surface
11 Sales space
12 Cash register (POS register)
13 Terminal communication device
14 Product display shelf
15 Product
16 Sales clerk
17 POS register body device
18 POS register accounting unit
19 POS register display device
20 Display-frame-embedded digital camera
21 Terminal body device
22 Terminal display device
23 Antenna
24 (24a, 24b) Input-output terminal
25 Connecting wire
26 USB port
27 Wired port
28 Personal computer
29 Digital-signage OEL
31 USB type flash memory
32 Portable telephone
33 Code-issuance machine
34a Left hand
34b Right hand
35 Input key
36 Rolled paper sheet whose backside is glued and to which a backing sheet is attached
37 Product code
   37a Barcode
   37b Two-dimensional code
38 Price tag
39 IC tag
41 Reader
42 Men's coat as an example of clothing
43 Bag as an example of a leather product
44 Sofa as an example of furniture
45 Ring as an example of jewelry or precious metals
46 Single-lens reflex electronic camera as an example of a portable electronic device
47 Fish as an example of a fresh food
48 Virtual-store product code
49 Backing sheet
50 Tenant contract function
51 Maintenance management function
52 Charging function
53 Credit card function
54 Point management function
55 Currency conversion function
56 Electronic money function
57 Credit loan function
58 Delivery work function
59 Marketing function
60 CPU (central processing unit)
61 RAM (Random Access Memory)
62 ROM (read only memory)
63 HD (hard disk)
64 Bus
65 Storage unit
65-1 DB (database) unit
65-2 Inventory management server
65-3 CMS (Content Management system) server
65-4 Charge management server
65-5 Mail server
66 Photograph database region
67 Blog function
68 I/F (interface) unit
69 Network adaptor
71 Terminal
72 Keyboard/mouse
73 Monitor
74 External storage device
75a, 75b Virtual store communication network
76 Virtual store
77 Portable-phone-version virtual store (Portable phone virtual store)
78 Another virtual store
79 Another portable-phone-version virtual store (Another portable phone virtual store)
80 Purchaser
81 Input terminal device
81-1 Personal computer
81-2 Portable telephone
81-3 Portable audio
81-4 Digital-signage OEL
81-5 PDA (personal digital assistant) terminal
81-6 TV
81-7 Digital camera
81-8 Digital movie
82 (82a, 82b, 82c, 82d) Provider
83 Small-size terminal communication device
84 Body device
85 Display device
86 Antenna
87 Data input key
88 (88a, 88b) Input-output terminal
89 Connection line for connection to a commercial power supply
90 Display-frame-embedded digital camera
91 USB port
92 Wired port
93 Facsimile machine
94 Display screen
95 Telephone
96 Display screen

1. A tenant store sales promotion management system, comprising:
a product information recording device installed at a sales space of a tenant store, wherein the product information recording device records, via an input operation by a sales clerk who sells a product of the tenant store, product information composed of at least a product name code, initial inventory quantity data, sales price data, sales volume data, and the like relating to the products;
a terminal communication device exclusively connected to the product information recording device in a wired or wireless fashion, wherein the terminal communication device reads the product information registered in the product information recording device and is capable of performing a communication relating to the read product information through a radio communication network connected to a virtual store; and
a server belonging to a company owning the terminal communication device, wherein the server communicates with the terminal communication device through the radio communication network, wherein:
after the terminal communication device transmits the product information to the server, when there is at least a product determined not to be presented for sale at the virtual store, the terminal communication device performs a process for transmitting, to the server, the product information of the product determined not to be presented for sale and transmitting, to the server, image data of products presented for sale and not including the product determined not to be presented for sale in order to add the image data to the product information of the products presented for sale;
the server performs at least
a process for registering, in a storage unit as a database, the product information composed of the product code, the initial inventory quantity data, the sales price data, and the image data of the products presented for sale, and information for identifying the sales space of the tenant store, via a communication from the terminal communication device,
a process for registering, into a virtual store reception site connected to the radio communication network, the virtual store exhibiting, as a product presented for sale, the product relating to the product information registered in the storage unit,
a process for obtaining sales information of the product sold at the virtual store,
a process for transmitting the obtained sales information to the terminal communication device, and
a process for charging a purchaser who purchased the product at the virtual store for the product on the basis of the sales information.

2. The tenant store sales promotion management system according to claim 1, wherein
the tenant store includes a tenant store of a large retail store, a tenant store of a store space rental business, a sales-space cash desk of large distribution industries, an accounting department of a wholesale company, an accounting department of a private shop, an accounting department of a product manufacturing factory, or a nonstore-type private vendor.

3. The tenant store sales promotion management system according to claim 1, wherein
the product information recording device includes a cash register or a personal computer.

4. The tenant store sales promotion management system according to claim 1, wherein
the terminal communication device comprises a plurality of connection ports connectable to at least an embedded digital camera, a product code issuance machine, a product code reader, a product image shooting machine, and a language translating machine.

5. The tenant store sales promotion management system according to claim 1, wherein
the terminal communication device reads the product code of a clearance product designated as a clearance sale object via an input operation by the sales clerk from among the products registered in the product information recording device, generates clearance information which is the same as the product code but with data indicating that the product is a clearance product and clearance sales price data input by the sales clerk being added to this product code, and transmits the clearance information to the server, and
on the basis of the received clearance information, the server performs a process for giving, to the clearance product, a product code that is different from a product code of a same product as the clearance product registered in the storage unit so as to deal with the clearance product as a product newly presented for sale at the virtual store, and performs a process for deleting the product information of the same product from the registration in the storage unit.

6. The tenant store sales promotion management system according to claim 1, wherein
when a product code of a product determined not to be newly presented for sale is reported from the terminal communication device while the product registered in the storage unit is being displayed at the virtual store, the server performs a process for deleting, from the registration in the storage unit, the product information of the product relating to the product code.

7. The tenant store sales promotion management system according to claim 1, wherein
when a display of the number of products in stock of the products at the virtual store registered in the storage unit displays zero, the server performs a process for automatically deleting an exhibition page of the virtual store relating to the product.
